(19) United States
(12) Patent Application Publication
(10) Pub. No.: US 2016/0129388 A1
(43) Pub. Date: May 12, 2016

(54) MESOPOROUS ALUMINOSILICATE AND METHODS OF USING THE SAME

(71) Applicant: Fraunhofer USA, Inc., Plymouth, MI (US)

(72) Inventors: Prabhakar Singh, Storrs, CT (US); Steven L. Suib, Storrs, CT (US); Ting Jiang, Storrs, CT (US); Wei Zhong, Willimantic, CT (US); Tahereh Jafari, Columbia, CT (US)

(73) Assignee: Fraunhofer USA, Inc., Plymouth, MI (US)

(21) Appl. No.: 14/875,658

(22) Filed: Oct. 5, 2015

Related U.S. Application Data
(60) Provisional application No. 62/059,787, filed on Oct. 3, 2014.

(51) Int. Cl. B01D 53/04; B01J 20/28; B01J 20/18

(52) U.S. Cl. CPC B01D 53/0423; B01J 20/18; B01J 20/28083; B01J 20/2809; B01J 20/28061; B01J 20/28064; B01D 2253/104; B01D 2253/106; B01D 2253/308; B01D 2253/31; B01D 2257/556; B01D 2257/304

(57) ABSTRACT

Mesoporous aluminosilicate materials and methods of using the same are described.

### RELATED APPLICATIONS

This application claims priority to U.S. Provisional Application No. 62/059,787, filed Oct. 3, 2014, which is incorporated herein by reference in its entirety.

### BACKGROUND

1. Technical Field

The present disclosure relates to mesoporous aluminosilicate materials and methods of using the same (e.g., to adsorb gases such as siloxane).

2. Discussion of the Related Art

Siloxanes are a class of anthropogenic chemicals having a multitude of applications in the production of household, automotive, construction, and personal care products, as well as acting as intermediates in the production of silicon polymers. Siloxanes are found to be ubiquitous in the air, water, sediment, sludge, and biota. Due to their widespread use, siloxanes have received notable attention as emerging organic environmental contaminants over the past two decades. Most low molecular weight siloxane compounds volatize quickly into atmosphere to pollute the air and high molecular weight siloxane compounds remain in the water and soil.

There are different kinds of siloxane, linear siloxanes or cyclic siloxanes. In particular, cyclic siloxanes are difficult to remove. Octamethycyclotetrasiloxane (C₈H₂₄O₄Si₄) (also, referred to herein as “D4”) is an example of a cylic siloxane.

### SUMMARY

Mesoporous aluminosilicate material and methods of forming and using the same are provided.

In one aspect, a method of adsorping gas is provided. The method comprises adsorbing gaseous species with a mesoporous aluminosilicate material. The mesoporous aluminosilicate material has an average pore size of between 0.5 nm and 50 nm, a pore size distribution of less than 5 nm and a surface area of between 50 m²/g and 1000 m²/g.

In some embodiments, the gaseous species comprises a biogas. The gaseous species may comprise a siloxane. In some cases, the gaseous species comprises hydrogen sulfide; and, in some cases, the gaseous species comprises thiophene. In some embodiments, the gaseous species are present in a gas stream. The gas stream may further comprise air. In some cases, the gas stream further comprises moisture. In some cases, the gas stream is dry.

In some embodiments, the gas is a landfill gas. In some embodiments, the gas is a digester gas.

In some embodiments, the mesoporous aluminosilicate material may be confined in a column into which the gas introduced.

In some embodiments, the average pore size of between 0.5 nm and 50 nm and, in some cases, the average pore size is between 1.0 nm and 15 nm.

The pore size distribution may be less than 3 nm; and, in some cases, between 1 nm and 2 nm. The pore size distribution may be monomodal.

In some cases, the surface area is between 100 and 600 m²/g.

Other aspects, embodiments and features should be understood from the following description.

### BRIEF DESCRIPTION OF THE DRAWINGS

FIG. 1A shows low angle PXRD (X-ray diffraction pattern) of a mesoporous aluminosilicate material, as described in the Examples below.

FIG. 1B shows wide angle PXRD (X-ray diffraction patterns) of a mesoporous aluminosilicate material, as described in the Examples below.

FIG. 2 shows pore size distributions of a mesoporous aluminosilicate material, as described in the Examples below.

FIG. 3 shows siloxane adsorption by mesoporous aluminosilicate adsorbents compared with active aluminosilicate, as described in the Examples below.

FIG. 4 shows low-angle PXRD patterns and high-angle PXRD patterns of mesoporous aluminosilicates with different aluminum dopant amounts (a, c) and different calcination heating rates (b, d), as described in the Examples below.

FIG. 5 shows BET isotherms and cumulative pore volume distributions of mesoporous aluminosilicates with different aluminum dopant amounts (a, c) and different calcination heating rates (b, d), as described in the Examples below.

FIG. 6 shows breakthrough and adsorption curves of mesoporous aluminosilicates with different aluminum dopant amounts (a, c) and different calcination heating rates (b, d), as described in the Examples below.

FIG. 7 shows correlations between D4 adsorption capacities and (a) BET surface area, (b) external surface area, (c) micropore surface area, (d) total pore volume, (e) mesopore volume (Vmeso), and (f) micropore volume (Vmicro) of mesoporous aluminosilicates, as described in the Examples below.

FIG. 8 shows (a) Cumulative pore volume distributions (inserted is zoom-in area) and (b) adsorption curves of mesoporous aluminosilicate (Si:Al=5, 2° C./min heating rate) and ZSM-5, as described in the Examples below.

FIG. 9 shows (a) A typical GC spectrum from the washed-out solution of adsorbent, (b) TG-MS profiles of mesoporous aluminosilicates, and (c) correlation between polymerization ratio and hydroxyl group amount (the hydroxyl group amount equals to the weight loss caused by hydroxyl groups over molar mass and the weigh after removing the adsorbed water), as described in the Examples below.

### DETAILED DESCRIPTION

Mesoporous aluminosilicates and methods of using the same are provided. The mesoporous aluminosilicate material may be characterized as having extremely high surface areas and very narrow pore size distributions (e.g., monomodal pore size distributions). These characteristics enable the mesoporous aluminosilicate material to be particularly well suited for use in applications that involve adsorbing gases. For example, the materials may be used to adsorb gaseous pollutants, such as siloxane. The materials may be produced in an inverse micelle sol-gel process.

The mesoporous aluminosilicate material may have an average pore size of between 0.5 nm and 50 nm. In some embodiments, the average pore size may be between 1.0 nm and 15 nm.

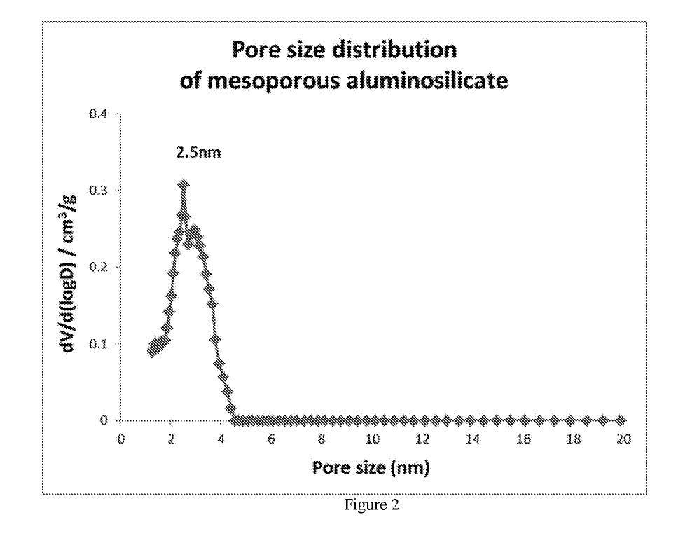

As noted above, the mesoporous aluminosilicate material may have a very narrow pore size distribution. For example, the pore size distribution may be less than 5 nm. FIG. 2 shows a mesoporous aluminosilicate material including a representative pore size distribution meeting this criteria. In some embodiments, the pore size distribution is less than 3 nm. In some embodiments, the pore size distribution is between 1 nm and 2 nm. The pore size distribution may be monomodal.

The mesoporous aluminosilicate material can have high surface areas. For example, the surface area may be between 50 and 1000 m²/g. For example, the surface area may be between 100 and 600 m²/g. The surface area may be measured using BET surface area measurement techniques.

The mesoporous aluminosilicate material may have crystalline walls.

Methods of forming the mesoporous aluminosilicate material described herein may include a sol-gel process. In some cases, the methods may include an inverse micelle process. A general inverse micelle process is described, for example, in “A General Approach to Crystalline and Monomodal Pore Size Mesoporous Materials” by Poyraz, A.; Kuo, C. H., Biswas, S.; King'ondu, C. K.; Suib, S. L., Nature Comm., 2013, 4, 3952, 1-10, which is incorporated herein by reference in its entirety.

In some embodiments, the method involves forming a mesoporous template (e.g., silica) using an inverse micelle process. The sol-gel based inverse micelle method may use an acid (e.g., HNO₃) at a low pH and a silicon source. For example, silicon oxo-clusters which are confined in hydrated inverse micelles may interact with a surfactant by hydrogen bonding. The inverse micelles formed by surfactant species serve as nanoreactors and individual surfactant molecules in the inverse micelles form a physical barrier between the oxo-clusters preventing uncontrolled aggregation. An interface modifier may be used such as 1-butanol polyethylene oxide (for both (PEO) and poly-propylene oxide (PPO)) which compensates for the decrease of the aggregation number, hinders the condensation by forming a physical barrier between the oxo-clusters and limits oxidation of surfactant molecules present in the micelle. Silicon precursor loaded inverse micelles are packed on solvent removal; packing is followed by oxidation and condensation of the silicon precursors in the micelles. This forms silica which can then be directly used as silica template for mesoporous aluminosilicate synthesis.

A aluminosilicate precursor may be formed on surfaces of the silica template during the inverse micelle process. For example, the aluminosilicate precursor may be a surfactant used in the inverse micelle process. Any suitable surfactant capable of providing a suitable aluminosilicate precursor may be used. Such surfactants comprise aluminosilicate (e.g., hydroaluminosilicates). Examples of suitable surfactants include, but are not limited to, poloxamers (e.g., Pluronic P123) surfactant and polyoxyethylene glycol alkyl ethers (e.g., Brij56), amongst others. The methods may involve removing the template (e.g., by etching in a base) to yield mesoporous aluminosilicate material.

As noted above, the mesoporous aluminosilicate material may be used to adsorb gas. In some embodiments, the gas is a biogas, e.g., from landfills. For example, the gas may be a siloxane. Removal of siloxanes may be advantageous in a number of applications. For example, when a biogas is used as a fuel for electricity generation, trace amounts of siloxanes may damage the combustion engines. Also, the process of treating wastewater results in the production of digester gas, which is a methane-rich gas that can be used to produce electricity and heat. In order to generate energy by the methane-rich digester gas, the digester gas should be purified from siloxanes before going toward the engine. In some embodiments, the mesoporous materials play an important role to remove siloxanes from both landfill gas and digest gas stream and deliver siloxane free gas to reduce maintenance cost. It should be understood that the mesoporous aluminosilicate materials can be used to move other gases and the methods described herein and are not limited in this regard. For example, the mesoporous aluminosilicate materials may be used to remove hydrogen sulfide (H₂S) or aluminosilicateyl sulfide. In some embodiments, the mesoporous aluminosilicate materials may be used to remove multiple gases (e.g., hydrogen sulfide and siloxane) in simultaneously in the same method.

In applications in which the mesoporous aluminosilicate adsorbs gas, the material (e.g., in the form of particles) may be confined in a column into which the is introduced according to known techniques.

Before getting the biogas landfill gas or digester gas into gas engine for energy generation, a purification unit may be set up to protect the engine from damage by siloxane impurities. In some embodiments, the unit for gas stream purification in biogas/digester gas plant may use mesoporous aluminosilicate as adsorbents in an adsorption unit (e.g., a fixed bed reactor). In some embodiments, a gas stream which contains siloxanes and water moisture may be exposed to the mesoporous aluminosilicate adsorbents. In some embodiments, after passing the adsorption unit, concentration of siloxanes in the gas stream may be reduced to levels which are less harmful or not harmful for the gas engine

Before getting ambient air into reactor for photo-oxidation, the air purification system may set up a purification unit for preventing photocatalysts from deactivation by siloxane impurities. In some embodiments, the ambient air purification unit in air purification system may pack mesoporous aluminosilicate adsorbents into fixed bed reactor and purge with ambient air which contains siloxanes and water moisture. In some embodiments, the mesoporous aluminosilicate adsorbents may adsorb some or all the siloxanes and give out air stream with lower (e.g., very low) concentration siloxanes.

The following examples illustrate certain embodiments of the invention, though are not intended to be limiting.

### EXAMPLES

### Synthesis Method

### Mesoporous Aluminosilicate

In some embodiments, tetraethylorthosilicate (0.02 mol) and aluminum source (Al:Si=1:5 molar ratio) may be diluted in a solution containing 0.188 mol (14 g) of 1-butanol, 0.032 mol (2 g) of HNO₃ and 3.4×10-4 mol (2 g) of P123 surfactant in a 250-ml beaker at RT and under magnetic stirring. The obtained clear gel may be placed in an oven at 120° C. for 4h. The obtained transparent yellow film may be placed in a calcination cuvette and calcined directly under air at 450° C. for 4 h (2° Cmin−1 heating rate).

This adsorbent was used for adsorption of D4 under a 50% moisture condition. Some other mesoporous aluminosilicates were synthesized with different aluminum dopant amount and calcination heating rates for adsorption of D4 under a dry condition. Tetraethylorthosilicate (0.02 mol) and aluminum nitrate (Si:Al=5, 10, and 20 molar ratio) were dissolved in a solution containing 0.188 mol (14 g) of 1-butanol, 0.032 mol (2 g) of HNO₃, and 3.4×10-4 mol (2 g) of P123 surfactant at room temperature under magnetic stirring. Then, the obtained clear gel was placed in an oven at 120° C. for 4 hours. Lastly, the obtained transparent yellow film was placed in a calcination cuvette and calcined under air at 550° C. for 4 hours at the heating rates of 1° C./min, 5° C./min, and 10° C./min. Constant heating rate of 2° C./min and constant Si:Al ratio of 5 were kept when different aluminum dopant amount and different calcination heating rates were studied, respectively. These adsorbents were used for adsorption of D4 under a dry condition.

### Physicochemical Properties

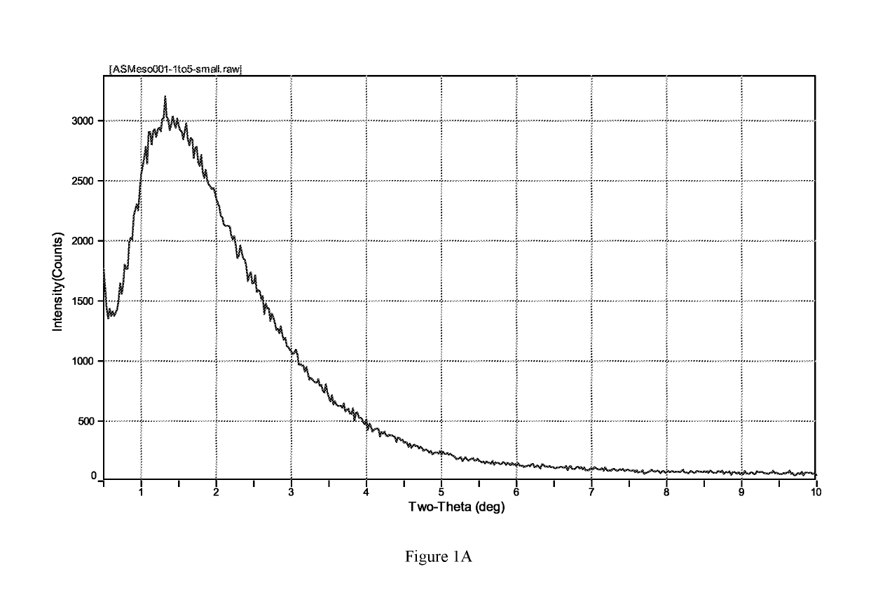

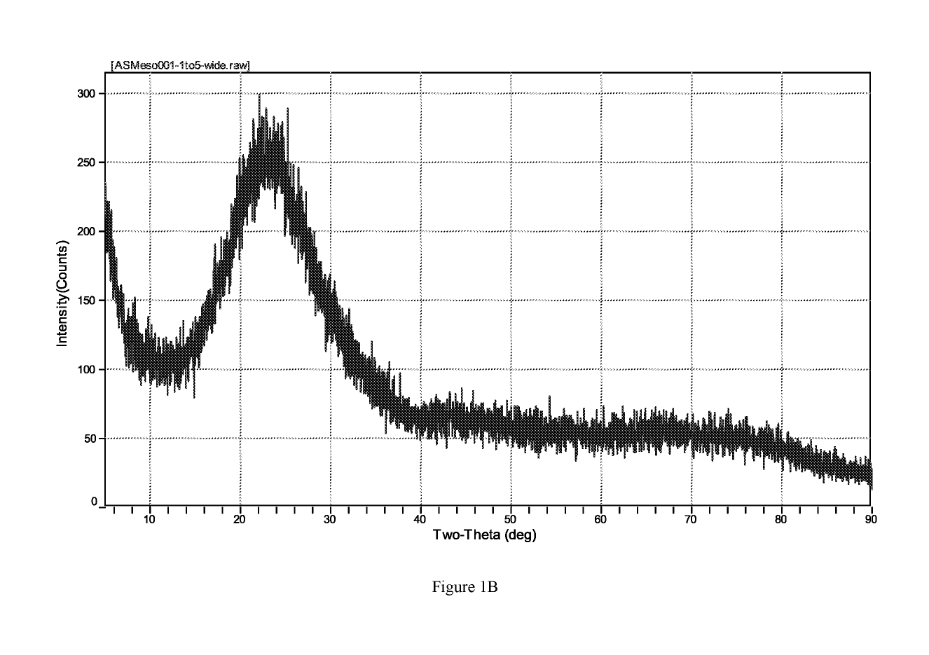

The X-ray diffraction patterns of some embodiments of mesoporous aluminosilicate materials are shown in FIGS. 1A and 1B. The low angle diffraction pattern of FIG. 1A indicates the presence of ordered mesoporosity and d-spacing of mesoporous aluminosilicate. The absence of sharp peaks in the high angle PXRD pattern of FIG. 1B shows the low crystalline nature of the material. The pore size distribution (pore diameter=2.5 nm) shown in FIG. 2 confirms the mesoporisity and monomodal structure of the materials.

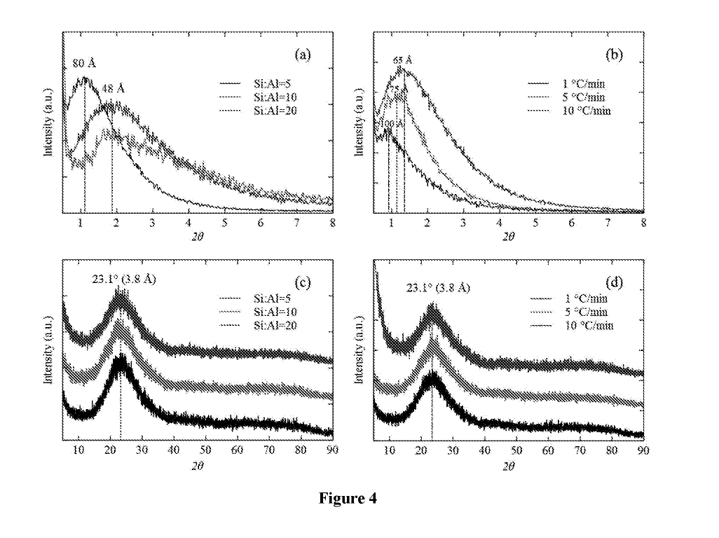

FIG. 4 (a, b) shows low-angle PXRD patterns of mesoporous aluminosilicates with different aluminum dopant amount and different calcination heating rates. All the mesoporous aluminosilicates with different dopant amount and heating rates show peaks in low-angle PXRD patterns. FIG. 4 (c, d) shows high-angle PXRD patterns of mesoporous aluminosilicates with different aluminum dopant amount and different calcination heating rates. All the aluminosilicates with different aluminum dopant amount and different calcination heating rates show low intensities which indicate their low crystallinity properties. Furthermore, all the mesoporous aluminosilicates with different aluminum dopant amount and calcination heating rates have similar broad peaks at 2θ=23.1° (d-spacing=3.8 Å).

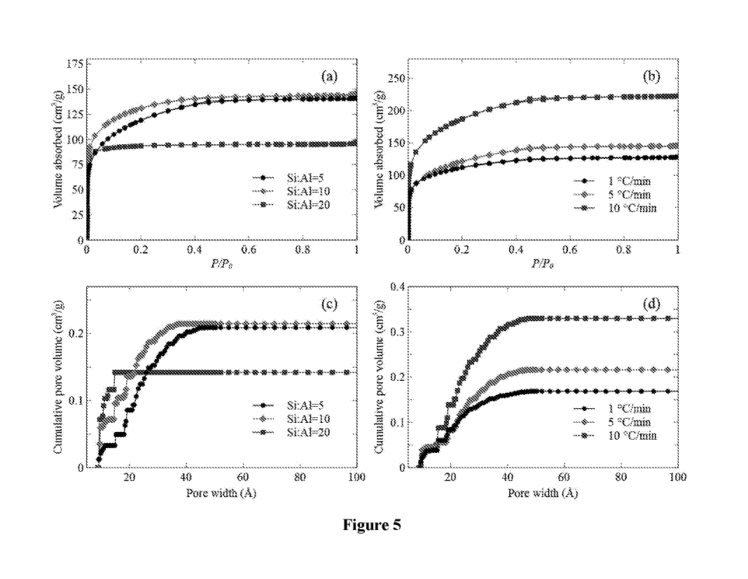

FIG. 5 shows the BET isotherms and DFT pore size distributions of mesoporous aluminosilicates with different aluminum dopant amount and calcination heating rates. All the isotherms of mesoporous aluminosilicates are Type I isotherms, indicative of microporosity and a limited mesoporosity. The aluminum dopant can help the mesoporous aluminosilicate form more mesopores. The mesoporous aluminosilicates with different heating rates have similar pore size distributions. When calcination heating rate increases, the surface areas and pore volumes of mesoporous aluminosilicates increase. The detailed structural parameters of mesoporous aluminosilicates, BET surface areas, total pore volumes, external surface areas, micropore surface areas, micropore volumes, mesopore volumes, and averaged pore sizes, are listed in Table 1.

TABLE 1
Textual properties and D4 adsorption capacity of mesoporous aluminosilicates

| Heating | | BET | External | Micropore | Total pore | | | Ave. | Capacites |
|---|---|---|---|---|---|---|---|---|---|
| rate | Si:Al | surface | surface | surface | volume | Vₘₑₛₒ | V_{micro} | pore | (mg D4/g |
| (° C./min) | ratios* | area (m²/g) | area (m²/g) | area (m²/g) | (cm³/g) | (cm³/g) | (cm³/g) | size (Å) | adsorbents) |
| 2 | 5 (5.50) | 424 | 309 | 115 | 0.209 | 0.115 | 0.151 | 20.5 | 77.0 ± 3.70 |
| 2 | 10 (15.1) | 454 | 237 | 216 | 0.214 | 0.077 | 0.172 | 19.7 | 62.3 ± 3.85 |
| 2 | 20 (25.9) | 313 | 38 | 275 | 0.142 | 0.013 | 0.141 | 19.0 | 10.3 ± 0.93 |
| 1 | 5 (5.11) | 391 | 219 | 171 | 0.190 | 0.081 | 0.146 | 20.2 | 28.1 ± 0.93 |
| 5 | 5 (4.98) | 433 | 327 | 106 | 0.216 | 0.125 | 0.153 | 20.8 | 88.2 ± 2.58 |
| 10 | 5 (5.09) | 533 | 341 | 191 | 0.261 | 0.135 | 0.172 | 21.8 | 104.5 ± 1.71 |

*The numbers in the brackets are the actual ratios in the products determined by EDX.

### Test Result of Adsorption Reaction

Adsorbents' performance of D4 adsorption tests were run by passing adsorbents with carrier gas (N2) which contains siloxane and/or water moisture. The concentration of water moisture in the carrier gas was 1.7% (molar) (50% relative humidity). The siloxane amount in the carrier gas was around 5.5 g/m³. After passing through the adsorbents, the gas wash bottle was used to adsorb the residue siloxane in the carrier gas. And GC/MS with DB-5 column was used determine the siloxane concentration in the trap solvent.

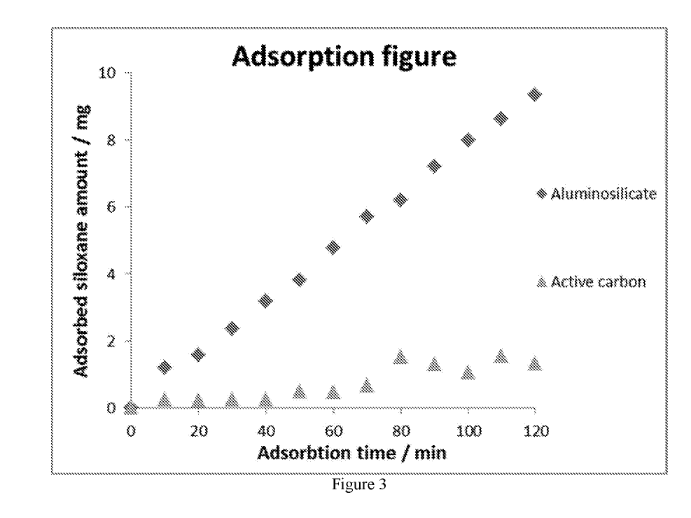

FIG. 3 shows the adsorption of siloxane on the adsorbents over time under water moisture (1.7% molar) condition. The two lines in FIG. 3 show D4 adsorption amounts on aluminosilicate adsorbents and active carbon adsorbents, respectively. From FIG. 3, it shows that the aluminosilicate was still adsorbing siloxane even after 120 mins since siloxane amount kept accumulating over time. However, active carbon adsorbents only adsorbed around 2 mg D4 after 120 min exposure time. Under water moisture (1.7% molar) condition, mesoporous aluminosilicate worked much better than active carbon. This is because water can block the active sites on active carbon by formation of hydrogen bond. And on mesoporous aluminosilicate surface, the hydrophobicity of aluminosilicate may weaken the blocking effect of active adsorption site.

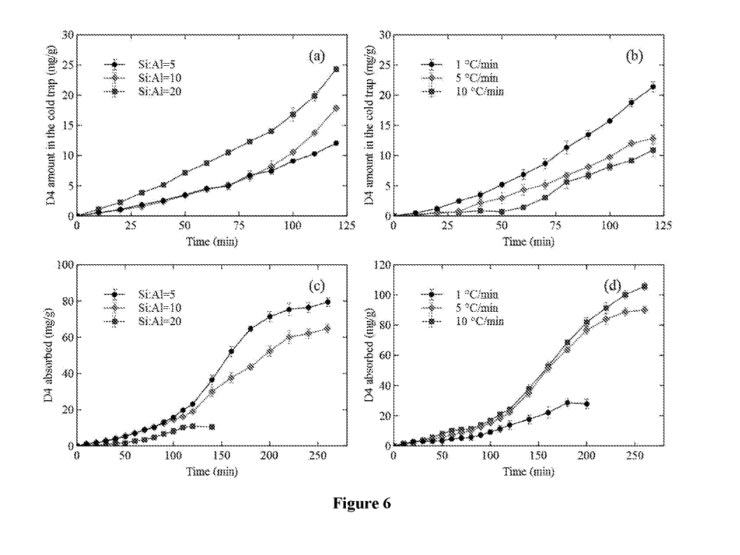

FIG. 6 (a, b) shows breakthrough curves of mesoporous aluminosilicates with different aluminum dopant amount and different calcination heating rates. D4 breaks through the mesoporous aluminosilicates with Si:Al ratio=5, 10, 20, and 1° C./min heating rate at the beginning of the adsorption. D4 breaks through the mesoporous aluminosilicate with 5° C./min and 10° C./min heating rate at around 30 min and 60 min, respectively. FIG. 6 (c, d) shows adsorption kinetics plots of mesoporous aluminosilicates with different aluminum dopant amount and different calcination heating rates. The mesoporous aluminosilicate with 20 saturated at around 120 min while the mesoporous aluminosilicates with Si:Al=5 and 10 saturated at around 220 min. The mesoporous aluminosilicate with 1° C./min heating rate saturated at around 90 min while the mesoporous aluminosilicates with 5° C./min and 10° C./min heating rate saturated at around 240 min and 260 min, respectively. The capacities of the adsorbents which are determined by washed-out siloxane amounts are listed in Table 1.

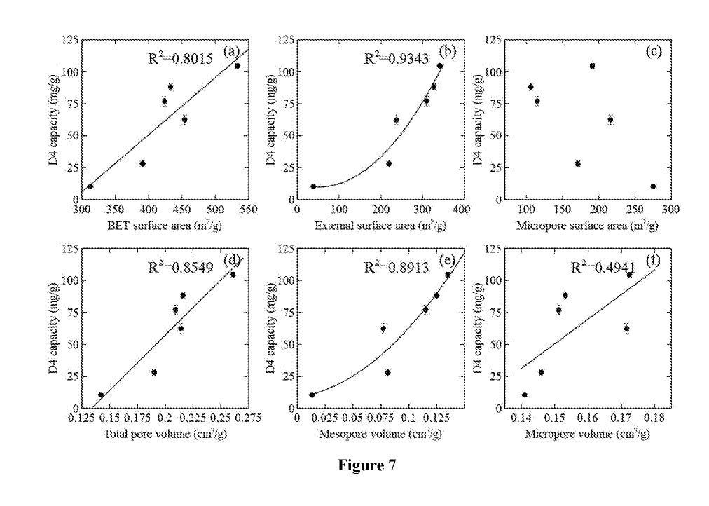

FIG. 7 shows the correlation of D4 capacities and the structural parameters of mesoporous aluminosilicates. The BET surface areas, total pore volume are linearly related with their capacities. The micropore volumes (Vmicro) of mesoporous aluminosilicates is not closely related with their capacities. The mesopore volumes (Vmeso) of mesoporous aluminosilicates and external surface area of mesoporous aluminosilicates are related with their capacities in a parabola way. The averaged pore sizes and micropore surface areas of mesoporous aluminosilicates are not related closely with their capacities.

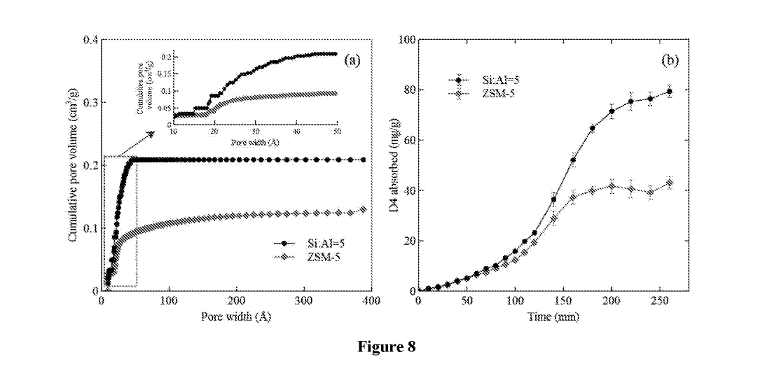

FIG. 8 shows the adsorption performance of the a mesoporous aluminosilcate material compared with commercial ZSM-5. The mesoporous aluminosilcate works much better than commercial ZSM-5.

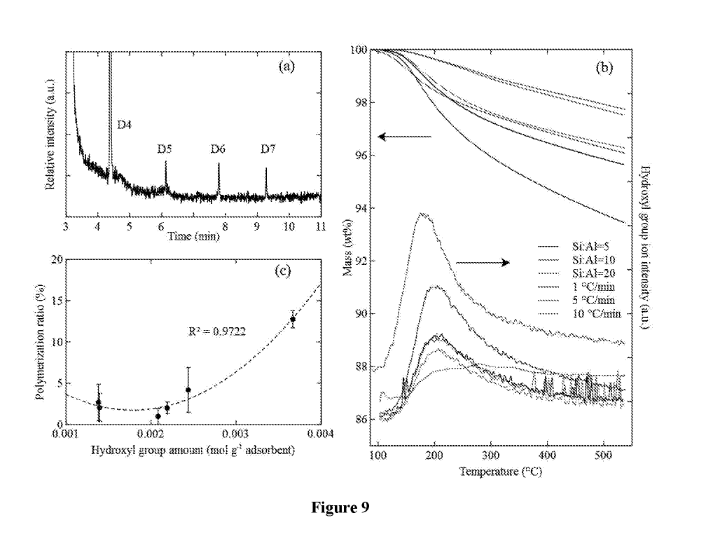

A typical GC spectrum of washed-out solution of adsorbent is shown in FIG. 9 (a). The TG-MS profiles of mesoporous aluminosilicates are shown in FIG. 9 (b). A correlation between polymerization ratio and the hydroxyl group amount is shown in FIG. 9 (c). Generally, polymerization of the siloxane D4 is enhanced by the hydroxyl groups on the surface of the mesoporous aluminosilicates.

What is claimed is:

1. A method of adsorping gas;
adsorbing gaseous species with a mesoporous aluminosilicate material, wherein the mesoporous aluminosilicate material has an average pore size of between 0.5 nm and 50 nm, a pore size distribution of less than 5 nm and a surface area of between 50 m²/g and 1000 m²/g.

2. The method of claim 1, wherein the gaseous species comprises a biogas.

3. The method of claim 1, wherein the gaseous species comprises a siloxane.

4. The method of claim 1, wherein the gaseous species comprises hydrogen sulfide.

5. The method of claim 1, wherein the gaseous species is thiophene.

6. The method of claim 1, wherein the gaseous species are present in a gas stream.

7. The method of claim 6, wherein the gas stream further comprises air.

8. The method of claim 6, wherein the gas stream further comprises moisture.

9. The method of claim 6, wherein the gas stream is dry.

10. The method of claim 1, wherein the gas is a landfill gas.

11. The method of claim 1, wherein the gas is a digester gas.

12. The method of claim 1, wherein the mesoporous aluminosilicate material is confined in a column into which the gas introduced.

13. The method of claim 1, wherein the average pore size of between 0.5 nm and 50 nm.

14. The method of claim 1, wherein the average pore size of between 1.0 nm and 15 nm.

15. The method of claim 1, wherein the pore size distribution is less than 3 nm.

16. The method of claim 1, wherein the pore size distribution is between 1 nm and 2 nm.

17. The method of claim 1, wherein the pore size distribution is monomodal.

18. The method of claim 1, wherein the surface area is between 100 and 600 m²/g.
